(19) United States
(12) Patent Application Publication
(10) Pub. No.: US 2011/0069502 A1
(43) Pub. Date: Mar. 24, 2011

(54) Mounting Fixture for LED Lighting Modules

(76) Inventor: David Hum, San Bruno, CA (US)

(21) Appl. No.: 12/760,197

(22) Filed: Apr. 14, 2010

(51) Int. Cl. F21V 29/00

(52) U.S. Cl. 362/373

(57) ABSTRACT

A mounting fixture for a light-emitting device such as an LED is disclosed. The fixture includes a base having a cavity adapted to receive a module having a light-emitting device mounted thereon, a cover, power contacts that provide electrical connections to the light-emitting device, a spring and a closure. The base has a heat-conducting surface. The cover has a window positioned to allow light from the light-emitting device to pass through the window. The first and second power contacts have first and second portions, respectively, adapted to receive external power connections on an outer surface of the mounting fixture. The spring forces the module against the heat-conducting surface when the base is in a closed position relative to the cover, the module being manually removable from the base when the cover is in an open position relative to the base. The closure reversibly attaches the base to the cover.

### BACKGROUND OF THE INVENTION

Light emitting diodes (LEDs) are an important class of solid-state devices that convert electric energy to light. Improvements in these devices have resulted in their use in light fixtures designed to replace conventional incandescent and fluorescent light sources. The LEDs have significantly longer lifetimes and, in some cases, significantly higher efficiency for converting electric energy to light.

Individual LEDs generate too little light for many applications that are currently based on incandescent or fluorescent light sources; hence, an LED light source that is intended to replace one of these conventional sources typically includes a plurality of LEDs that are mounted on a substrate such as a metal-core printed circuit board. The electrical connections are provided by soldering wires to pads on the circuit board or inserting a connector into a mating connector on the circuit board. In addition to electrical connections, the LEDs often require a thermal connection to a heat sink and heat-radiating structure that transfers the heat generated by the LEDs to the surrounding environment.

The thermal connections between the heat-dissipating structure and the LED module have been implemented in many different configurations. In general, the schemes involve attaching a heat-conducting surface in the module to the heat-dissipating structure using a thermally conductive medium to reduce the thermal resistance of the heat-conducting path and a mechanical connection to bond the module to the heat-conducting structure. In some systems, the module is attached by a thermally conductive adhesive to the heat-conducting structure. Thermally conductive tape or thermally conducting epoxy have been used to make the thermal connections. In other schemes, the module is attached to the heat-dissipating structure using screws.

While these methods are effective in providing thermal and electrical connections, these connection schemes complicate the replacement of the module. Field replacement of LED modules can be costly in many applications. If the module is located in a sign that is not easily reached by personnel, unsoldering leads and/or detaching the module from the heat-dissipating structure can impose significant costs which detract from the use of LEDs in many applications. In addition, the number of different mounting schemes makes it difficult to implement a standardized module scheme that can be used with a large variety of light modules.

In addition, many applications require the LED module to be located in a structure that includes secondary optics that operate on the light generated by the module. Schemes based on gluing the module to the heat sink in the field present challenges when precise registration of the LEDs relative to an external optical system is required.

Hence, it would be advantageous to provide an LED-mounting fixture that provides good heat dissipation while providing easy field replacement of the LED module and precise positioning of the LEDs relative to external optics.

### SUMMARY OF THE INVENTION

The present invention includes a mounting fixture comprising a base having a cavity adapted to receive a module having a light-emitting device mounted thereon, a cover, first and second power contacts that provide electrical connections to the light-emitting device, a spring and a closure. The base has a heat-conducting surface. The cover has a window positioned to allow light from the light-emitting device to pass through the window. The first and second power contacts have first and second portions, respectively, adapted to receive external power connections on an outer surface of the mounting fixture. The spring forces the module against the heat-conducting surface when the base is in a closed position relative to the cover, the module being manually removable from the base when the cover is in an open position relative to the base. The closure reversibly attaches the base to the cover.

### BRIEF DESCRIPTION OF THE DRAWINGS

FIG. 1 illustrates a mounting fixture 10 that is bonded to a heat-dissipating structure.

FIGS. 2 and 3 illustrate a module 23 that mates with mounting fixture 10 shown in FIG. 1.

FIG. 4 is a cross-sectional view of a mounting fixture in which the cover is attached to the base via a plurality of clips.

FIG. 5 is a cross-sectional view of a mounting fixture 50 having detent pins on the base surface of the cavity that holds the module.

FIG. 6 is a cross-sectional view of a portion of the base of mounting fixture with a portion of an LED module in place according to another aspect of the current invention.

FIG. 7 is a cross-sectional view of a portion of the base of mounting fixture with a portion of an LED module in place according to another aspect of the current invention.

FIG. 8 is a cross-sectional view of a mounting fixture according to another embodiment of the present invention.

FIG. 9 illustrates an embodiment of the present invention in which the base is formed from a recess in the heat-radiating element.

FIG. 10 is a cross-sectional view of a portion of heat-dissipating element 110 with a module 120 in base 111.

FIG. 11 is an exploded view of a light source according to another embodiment of the present invention.

FIG. 12 is a bottom view of the cover shown in FIG. 11.

### DETAILED DESCRIPTION OF THE PREFERRED EMBODIMENTS OF THE INVENTION

The manner in which the present invention provides its advantages can be more easily understood with reference to FIGS. 1-3, which illustrate an LED-mounting fixture according to one embodiment of the present invention and a module that mates with that mounting fixture. Refer first to FIG. 1, which illustrates a mounting fixture 10 that is bonded to a heat-dissipating structure 31 that includes a plurality of fins 32 that facilitate the transfer of heat from structure 31 to the surrounding environment. Mounting fixture 10 includes a base 11 that is bonded to heat-dissipating structure 31 in a manner that assures good thermal conduction between the bottom surface of base 11 and structure 31. For example, base can be adhesively bonded to heat-dissipating surface 31 using a heat-conducting epoxy or other thermal conductive medium. In general, base 11 is constructed from a good heat-conducting material such as a metal.

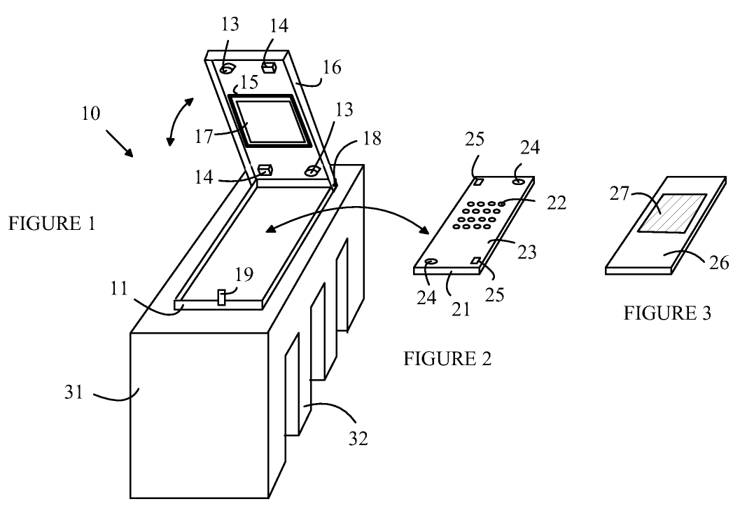

Refer now to FIGS. 2 and 3, which illustrate a module 23 that mates with mounting fixture 10. Module 23 includes a printed circuit board 21 on which a plurality of LEDs shown at 22 are mounted. Printed circuit board 21 includes a metal core that transfers the heat generated by the LEDs to a heat transfer surface 27 on the backside of printed circuit board 23 as shown in FIG. 3. Heat transfer surface 27 is typically a metal pad that is in good thermal contact with the metal core of printed circuit board 23. When module 23 is inserted in mounting fixture 10, heat transfer surface 27 is in thermal contact with base 11. In one aspect of the present invention, the thermal contact is enhanced by coating heat transfer surface 27 with a suitable heat-conducting medium.

Module 23 includes detents 24 that mate with corresponding pins 13 on cover 16 of mounting fixture 10. The detents and corresponding locating pins assure that module 23 is properly positioned in mounting fixture 10 such that LEDs 22 are at a predetermined position relative to window 17. Module 23 is powered through contacts 25 which make connection with a corresponding pair of contacts 14 shown in FIG. 1. Contacts 14 are preferably spring loaded so that a positive force is applied between contacts 25 and 14 when cover 16 is closed. This force insures good electrical contact between the contacts and also forces heat transfer surface 27 on the bottom surface 26 of module 23 against the bottom of base 11 to reduce the thermal resistance of the module-mounting fixture interface.

Cover 16 is hingedly connected to base 11 by hinge 18. When closed, cover 16 is held in place by latch 19. The force provided by contacts 14 forces cover and base away from each other and maintains the pressure needed for good electrical connections and heat conduction.

Window 17 can be implemented as an opening in cover 16 or be covered in a transparent material. In the former case, the LEDs are further cooled by contact with the surrounding environment. Window 17 can also be surrounded with a gasket 15 of compliant material that provides a seal around the LEDs that prevents debris from entering the interior of mounting fixture 10 when the upper and lower sections of mounting fixture 10 are in their closed configuration. If the compliant material is resilient, the gasket 15 also increases the force of contact between heat transfer surface 27 and base 11 of mounting fixture 10 when it is in a compressed state.

It should be noted that the bottom surface of base 11, or a portion thereof, could be missing to provide direct contact between heat transfer surface 27 and the top surface of structure 31. Such an arrangement provides improved heat transfer, since the intervening material is not present.

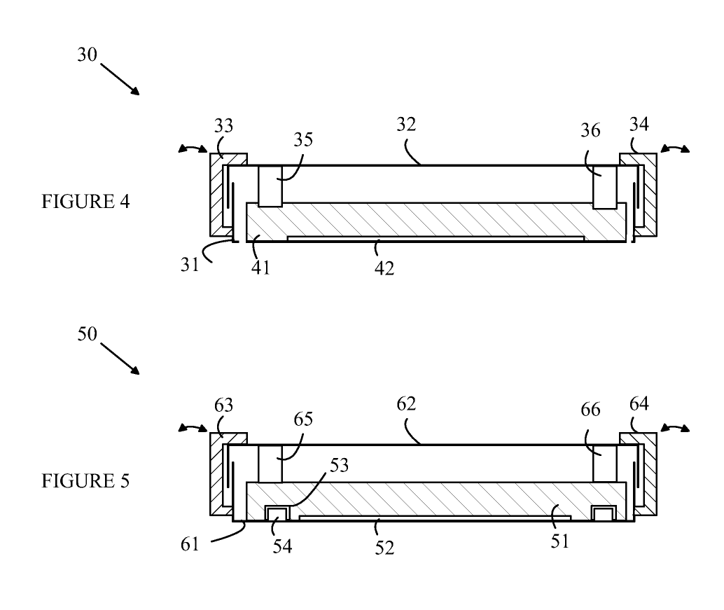

The above-described embodiments utilize an arrangement in which the two sections of the mounting fixture are hingedly connected to one another. However, other arrangements can be utilized. Refer now to FIG. 4, which is a cross-sectional view of a mounting fixture in which the cover is attached to the base via a plurality of clips. FIG. 4 also illustrates an embodiment in which the bottom surface of base 31 includes an opening that allows the module to rest on an underlying heat-dissipating surface that is not part of mounting fixture 30.

Mounting fixture 30 includes a plurality of clips that are attached to base 31. Exemplary clips are shown at 33 and 34. The clips are sufficiently compliant to allow cover 32 to be placed over base 31 and then moved into the closed position shown in FIG. 4. Detent pins such as pins 35 and 36 engage module 41 to position module 41 within mounting fixture 30. In one aspect of the invention, the detent pins are spring loaded such that the detent pins provide a downward force that presses module 41 against the bottom surface of base 31 to provide improved heat transfer between heat transfer surface 42 and the bottom surface of base 31.

Detent pins can also be located on the base surface of the mounting fixture. Refer now to FIG. 5, which is a cross-sectional view of a mounting fixture 50 having detent pins on the base surface of the cavity that holds the module. Pins such as pin 54 fit into mating recesses 53 in module 51. Heat is transferred to the surface of section 61 through heat transfer surface 52 that is forced against the surface when section 62 is attached to section 61 via clips 63 and 64. The force is provided by compliant members such as members 65 and 66 that contact the upper surface of module 51. Members 65 and 66 can be constructed from metallic springs that also function as conductors for making electrical contact with module 51. Alternatively, the mechanism for forcing module 51 against the surface of section 61 could be provided by a spring mechanism that is separate from the power contact that electrically connects module 51 to the mounting fixture.

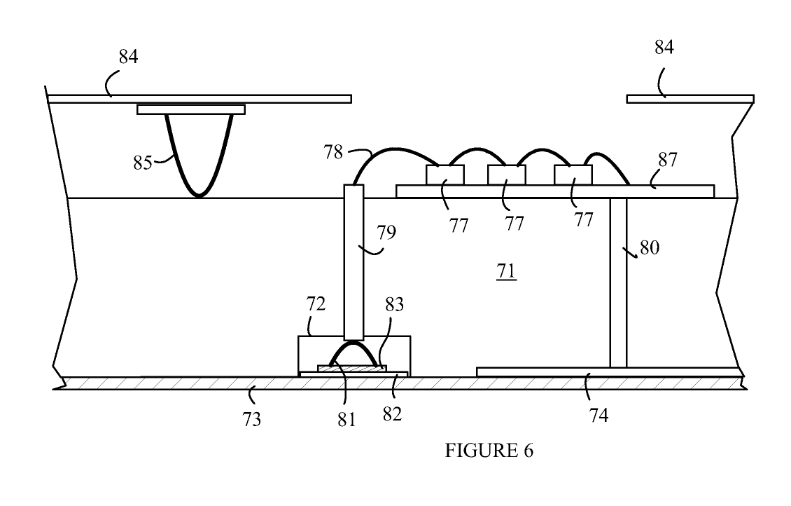

Refer now to FIG. 6, which is a cross-sectional view of a portion of the base of a mounting fixture according to one embodiment of the present invention with a portion of an LED module in place according to another aspect of the current invention. In this embodiment, one of the electrical contacts is utilized both as a detent pin and an electrical contact. The electrical contact is made by a spring 81 that is connected to an electrical trace 83 that is insulated from surface 73 by an insulating layer 82. Contact 72 is connected electrically to a plurality of LED dies 77 that are mounted on heat sink 87. Springs such as spring 85 force module 71 against surface 73 when section 84 is attached.

In this embodiment, the dies are powered by connections on the top surfaces of the dies, and the bottom surfaces of the dies are insulated from heat sink 87. The dies are connected in series by wire bonds and to contact 72 by conductors 78 and 79. In this embodiment, the heat sink acts as a second power terminal and is connected to heat conduction surface 74 by a conductor 80 that passes through the module. Surface 73 acts as the second electrical contact in this embodiment.

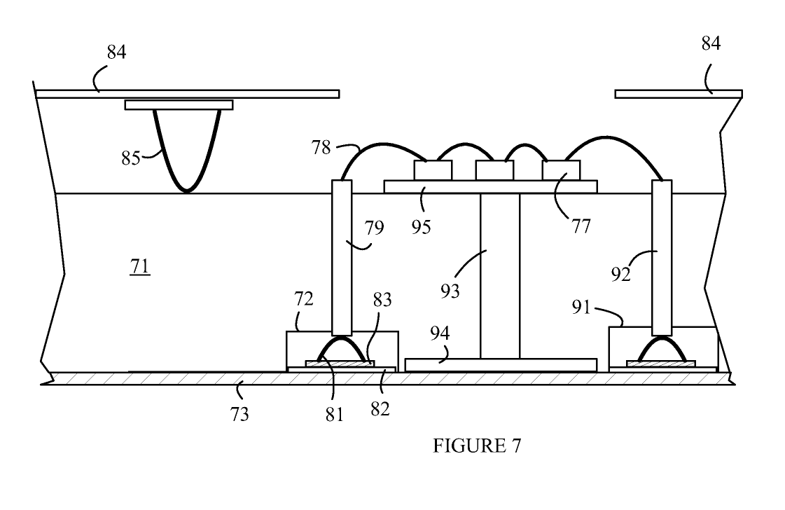

Refer now to FIG. 7, which is a cross-sectional view of a portion of the base of a mounting fixture according to one embodiment of the present invention with a portion of an LED module in place according to another aspect of the current invention. In this embodiment, both of the electrical contacts are utilized both as a detent pin and an electrical contact. In particular, the dies are connected in series between contacts 72 and 91. A vertical conductor shown at 92 provides the connection to contact 91. The dies are mounted on a heat sink 95 that is insulated from the dies. Heat sink 95 is thermally connected to heat-conducting surface 94 by a heat conductor 93, which is typically constructed from metal.

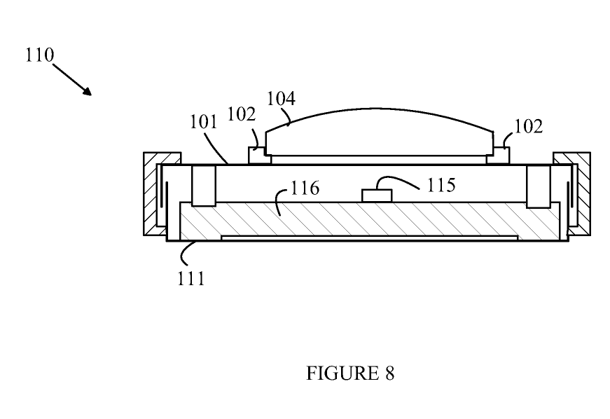

The cover of the mounting fixture can also include additional optical elements for processing the light generated by the LEDs on the enclosed module. Refer now to FIG. 8, which is a cross-sectional view of a mounting fixture according to another embodiment of the present invention. Mounting fixture 110 includes a base 111 and a cover 101. An LED 115 on enclosed module 116 is positioned under an optical element 104 that focuses, or otherwise processes, the light generated by LED 115. The optical element may be part of cover 101 or attached to cover 101 with the aid of an optical mount 102. Since the same base can be used with multiple covers, the optical elements can be customized for each application without requiring a special mounting fixture for each application.

Refer again to FIG. 1. While the mounting fixture is shown as being separate from heat-dissipating element 31, embodiments in which the mounting fixture is an integral part of some other structure, such as heat-dissipating element 31, can also be constructed. For example, the base of the mounting fixture could be a molded recess in a surface of the heat-dissipating element.

The manner in which power is connected to the mounting fixture from an external source so as to power the module contained therein will, in general, depend on the location of the power contacts. For example, in the embodiment shown in FIG. 1, the power contacts are on the moveable element 16. Accordingly, connections for power are more conveniently implemented on the surface of member 16 that is exposed when member 16 is in its closed position. The contacts can be provided by extending contacts 14 through member 16 and providing a connection or solder pad for the external power leads. If the power contacts are on the bottom surface of the mounting fixture as shown in FIG. 7, the contacts can be provided on an exposed edge of the bottom portion of the mounting fixture.

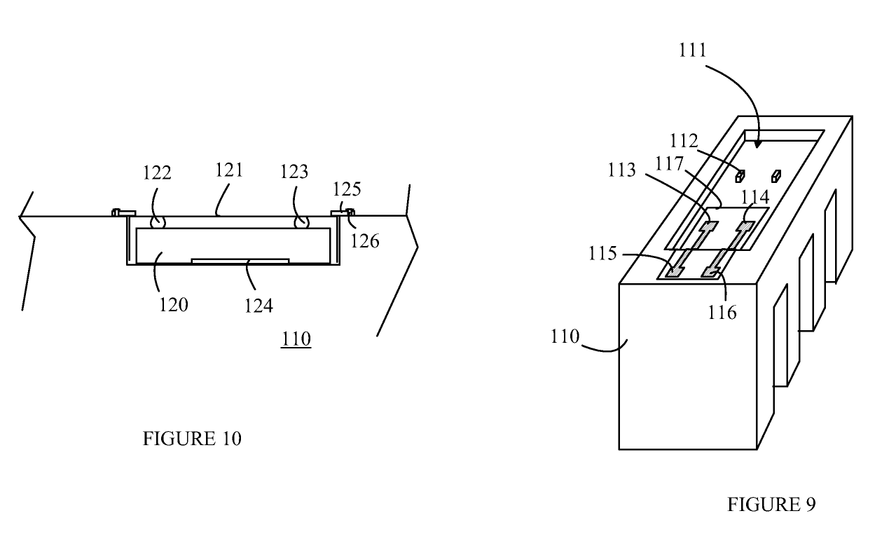

The embodiments shown in FIG. 1 utilize a base that is separate from the heat-radiating element. However, embodiments in which the base is formed from a recess in the heat-radiating element can also be constructed. Refer now to FIG. 9, which illustrates an embodiment of the present invention in which the base is so formed. Base 111 is a recess in heat-dissipating element 110. Pins 112 are molded into heat-dissipating element 110 and serve to position the module in base 111 by engaging matching recesses in the bottom of the module. In this embodiment, the power contacts for the module are on the bottom surface of the module and connect to contacts 113 and 114 that mounted on an insulating layer 117 that is bonded to the bottom surface of the base. Contacts 113 and 114 are connected by insulating traces to contacts 115 and 116 that are mounted on an outer surface that can be accessed to make connections to the module once the module is placed in the recess and covered. The contacts can be formed on a flexible printed circuit substrate.

Refer now to FIG. 10, which is a cross-sectional view of a portion of heat-dissipating element 110 with a module 120 in base 111. Cover 121 fits into the recess in base 111 and is held in place by rotating clips such as clip 125. Clip 125 rotates about a pin 126 so as to retain cover 121 in the recess. Pin 126 can be molded into heat-dissipating element 110. Spring members 122 and 123 force module 120 against the bottom surface of the recess to assure good thermal contact between heat-conducting surface 124 and heat-dissipating element 110. The spring members can be constructed from a compressible material such as foam rubber that is bonded to the underside of cover 121.

The above-described embodiments utilize pins or other positioning protrusions to maintain the position of the module in the base of the section during operation. However, other positioning mechanisms could be utilized. Any form of protrusion that engages a matching recess could be utilized, one of the two elements being associated with the mounting fixture and the other with the module. For example, seal 15 shown in FIG. 1 could engage a matching recess in module 21 to hold module 21 in place. In addition, if module 21 has dimensions that match those of the recess in the base, the sides of the module could provide the needed positioning. Positioning mechanisms that do not depend on the specific size of the recess have the advantage of allowing a range of module sizes to be accommodated in a single mounting fixture. To simplify the discussion of such various forms of positioning mechanisms, the term pin is defined to cover any form of protrusion that defines the position of the module when engaged with a complementary recess.

The above-described embodiments utilize various forms of catches to hold the cover in place with respect to the base such that an internal spring mechanism can force the module against the bottom of the base to provide heat conduction and reliable electrical conduction for powering the module. However, other attachment mechanisms could be utilized. For example, the cover could be screwed to the base. The catch mechanisms have the advantage of providing reversible attachment without requiring any special tools, and hence, have advantages in systems requiring field replacement of a module.

In the above-described embodiments, the base includes a recess into which the module is placed. However, the recess is optional. Refer now to FIG. 11, which is an exploded view of a light source according to another embodiment of the present invention. Light source 150 includes a heat-dissipating structure 151 that has a planar surface 156 on which module 155 is in contact during the operation of light source 150. A cover section 152 having the power connections and detents that engage module 155 is provided. Cover 152 is attached to heat-dissipating structure 151 by fasteners such as screw 154.

In one aspect of the invention, cover 152 includes hinges 153 that allow cover 152 to rotate upward such that module 155 can be accessed after cover 152 is attached to heat-dissipating structure 151. However, embodiments in which cover 152 lacks such hinges could also be constructed.

Cover 152 is forced downward onto surface 156 by securing an additional fastener 157, which could also be a screw as shown or other form of catch mechanism as described above. Contacts 168 are then forced against contacts 163 on cover 152 and module 155 is then positioned under window 161.

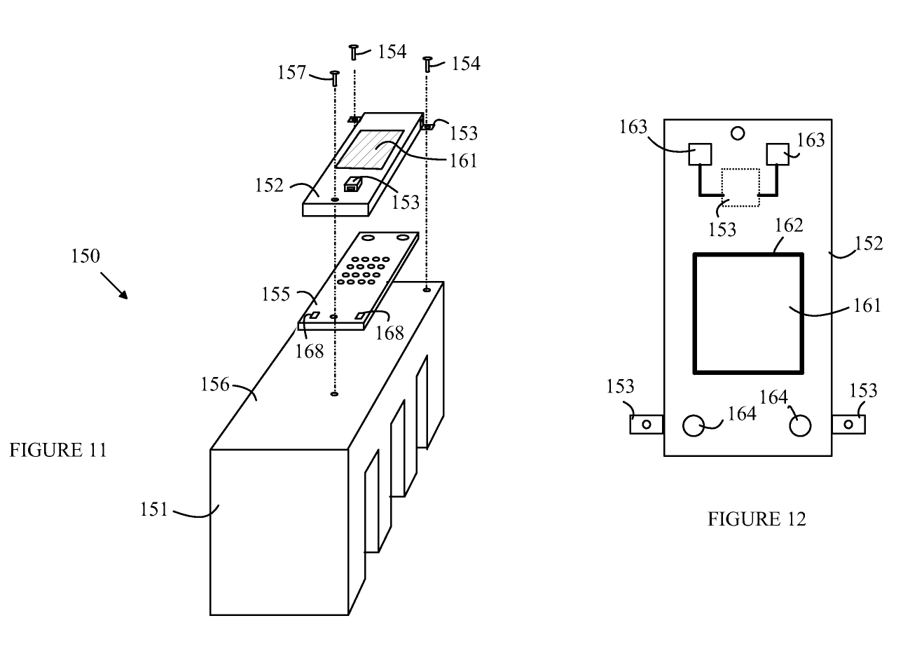

Refer now to FIG. 12, which is a bottom view of cover 152. Cover 152 includes one or more spring mechanisms that force module 155 against surface 156 and assure that good electrical contacts are made between conductors 163 within cover 152 and the corresponding contacts 168 on module 155 when cover 152 is secured in place. In one aspect of the invention, conductors 163 include a separate spring mechanism for assuring good electrical contact. These springs will also force module 155 against surface 156; however, additional springs can be utilized to assure good thermal contact. For example, window 161 could be surrounded by a compressible gasket 162 as described above or the detent pins 164 could be compressible.

Conductors 163 are connected to a connector 153 on the outer surface of cover 152 by conductors on the inside of cover 152. Connector 153 mates with a corresponding cable in the light source controller to power light source 150.

It should be noted that cover 152 could be supplied with module 155 by the manufacturer of module 155. In such a system, the luminaire manufacturer would supply heat-dissipating structure 151.

The above-described Summary of the Invention and embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. A mounting fixture comprising:
a base having a cavity adapted to receive a module having a light-emitting device mounted thereon, said base having a heat-conducting surface;
a cover having a window positioned to allow light from said light-emitting device to pass through said window;
first and second power contacts that provide electrical connections to said light-emitting device, said first and second power contacts having first and second portions, respectively, adapted to receive external power connections on an outer surface of said mounting fixture;
a spring that forces said module against said heat-conducting surface when said base is in a closed position relative to said cover, said module being manually removable from said base when said cover is in an open position relative to said base; and
a closure for reversibly attaching said base to said cover.

2. The mounting fixture of claim 1 wherein said cover is hingedly attached to said base.

3. The mounting fixture of claim 1 further comprising a positioning mechanism that fixes said module in a predetermined position within said base when said cover is in said closed position.

4. The mounting fixture of claim 3 wherein said positioning mechanism comprises a pin attached to one of said cover or base, said pin engaging a recess on said module.

5. The mounting fixture of claim 3 wherein said positioning mechanism comprises a recess in said base.

6. The mounting fixture of claim 1 wherein one of said first and second power contacts comprises a spring mechanism that forces said contacts against a corresponding contact on said module when said cover is in said closed position.

7. The mounting fixture of claim 1 wherein said base comprises a metal surface that is forced against a corresponding heat transfer surface on said module when said cover is in said closed position.

8. The mounting fixture of claim 1 wherein said closure comprises a clip attached to one of said base and said cover, said clip engaging the other of said base and said cover to hold said cover in said closed position.

9. The mounting fixture of claim 1 further comprising a heat-radiating structure having a surface area greater than said base.

10. The mounting fixture of claim 9 wherein said base comprises a recess in a surface of said heat-radiating structure.

11. The mounting fixture of claim 1 wherein said window comprises an optical element for focusing or collimating light generated by said light generating device.

12. The mounting fixture of claim 1 wherein said cover comprises a resilient seal that forms a seal between said cover and said module around said window, said resilient seal forcing said module against said heat-conducting surface when said cover is in said closed position.

13. The mounting fixture of claim 1 wherein said cover comprises a connector that reversibly mates with a power cable that powers said module.

14. A mounting fixture comprising:
a cover having a cavity adapted to receive a module having a light-emitting device mounted thereon, said cover having a window positioned to allow light from said light-emitting device to pass through said window;
first and second power contacts that provide electrical connections to said light-emitting device, said first and second power contacts having first and second portions, respectively, adapted to receive external power connections on an outer surface of said cover;
a spring that forces said module against a base having a heat-conducting surface when said cover is attached to said base in a closed position relative to said cover, said module being manually removable from said cover when said cover is in an open position relative to said base; and
a closure for reversibly attaching said cover to said base.

15. The mounting fixture of claim 14 wherein said cover comprises a detent for positioning said module in said cover when said cover is in said closed position.

16. The mounting fixture of claim 14 wherein said first and second power contacts comprise springs that force said first and second power contacts against corresponding first and second contacts on said module.

17. The mounting fixture of claim 14 comprising a connector on a surface of said cover, said connector mating with a cable that provides power to said module.
